(19) United States
(12) Patent Application Publication
(10) Pub. No.: US 2017/0290057 A1
(43) Pub. Date: Oct. 5, 2017

(54) SYSTEMS AND METHODS FOR ENHANCING CELL-EDGE STATIONS

(71) Applicants: Juan Fang, Hillsboro, OR (US); Minyoung Park, Portland, OR (US)

(72) Inventors: Juan Fang, Hillsboro, OR (US); Minyoung Park, Portland, OR (US)

(21) Appl. No.: 15/088,657

(22) Filed: Apr. 1, 2016

(51) Int. Cl. H04W 74/08

(52) U.S. Cl. CPC H04W 74/0816

(57) ABSTRACT

This disclosure describes methods, apparatus, and systems related to a MAC protocol that can coordinate the AP with a relay STA to improve both the uplink and downlink throughput of a CE STA by using underutilized secondary channels. The disclosed systems and methods can be used to improve the performance of cell-edge STAs without affecting the performance of non-cell-edge STAs. In various embodiments, RTS frames can be used to instruct relay STAs to transmit data to CE STAs over idle secondary channels while the AP transmits data to legacy (e.g. 20 or 40 MHz) STAs over primary channels.

### TECHNICAL FIELD

This disclosure generally relates to systems and methods for wireless communications and, more particularly, systems and methods for enhancing cell-edge stations.

### BACKGROUND

Wireless devices are becoming widely prevalent and are increasingly requesting access to wireless channels. A next generation WLAN, IEEE 802.11ax or High-Efficiency WLAN (HEW), is under development. HEW utilizes Orthogonal Frequency-Division Multiple Access (OFDMA) in channel allocation.

### BRIEF DESCRIPTION OF THE DRAWINGS

FIG. 1 shows a diagram of underutilized secondary channels due to the 20 MHz transmission between an AP and an STA (e.g. 802.11a/n 20 MHz STA) in accordance with an example embodiment of the systems and methods disclosed herein.

FIGS. 2A and 2B show diagram illustrating systems and methods of using non-CE STAs (STA2) as relay to improve the uplink throughput of CE STA (STA3) in accordance with an example embodiment of the systems and methods disclosed herein.

FIG.3 shows an exemplary network environment in accordance with an example embodiment of the systems and methods disclosed herein.

FIGS. 4A and 4B show diagrams illustrating the proposed MAC protocol that coordinates transmission from the AP to the 20 MHz STA and from the relay STA to the CE STA in accordance with an example embodiment of the systems and methods disclosed herein.

FIG. 5 shows a flowchart of the operation of an exemplary AP is provided in accordance with embodiments of the systems and methods disclosed herein.

FIG. 6 shows a flowchart of the operation of an exemplary relay STA is provided in accordance with embodiments of the systems and methods disclosed herein.

FIG. 7 shows a flowchart of the operation of an exemplary CE STA is provided in accordance with embodiments of the systems and methods disclosed herein.

FIG. 8 shows a diagram of the throughput of CE STA in accordance with embodiments of the systems and methods disclosed herein.

FIG. 9 illustrates a functional diagram of an example communication station that may be suitable for use as a user device, in accordance with one or more example embodiments of the disclosure.

FIG. 10 is a block diagram of an example machine upon which any of one or more techniques (e.g., methods) may be performed, in accordance with one or more embodiments of the disclosure.

### DETAILED DESCRIPTION

Example embodiments described herein provide certain systems, methods, and devices, for providing signaling information to Wi-Fi devices in various Wi-Fi networks, including, but not limited to, IEEE 802.11ax (referred to as HE or HEW).

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

The present disclosed systems and methods are directed to a long range mode of operation in, for example, HEW, with a range longer than accounted for in IEEE 802.11ac. HEW can use Orthogonal Frequency-Division Multiple Access (OFDMA) to encode digital data on multiple carrier frequencies.

IEEE 802.11ac can support high throughput data transmission and reception by using a wider channel bandwidth (e.g., 80 MHz, or optionally 160 MHz). However, the access point (AP) of a basic service set (BSS) cannot always use 80 MHz channel bandwidth at least for the reasons that: (1) an associated station (STA) is a non-802.11ac STA (e.g., 802.11a or 802.11n). and (2) A STA is at the edge of the coverage area of the BSS and cannot communicate using 80 MHz channel bandwidth due to low signal-to-noise (SNR) characteristics. In the case of (1) and (2), the AP may have to transmit data in a 20 MHz or 40 MHz channel bandwidth.

In some situations, an 802.11ac AP may only use 20 MHz or 40 MHz channel bandwidth to communicate with an associate STA. This can cause underutilization of secondary channels.

Conventional approaches have been directed to the basic concept of using the underutilized spectrum to improve the performance of cell-edge STAs (CE STAs). However, the conventional approaches still waste significant secondary channel capacity.

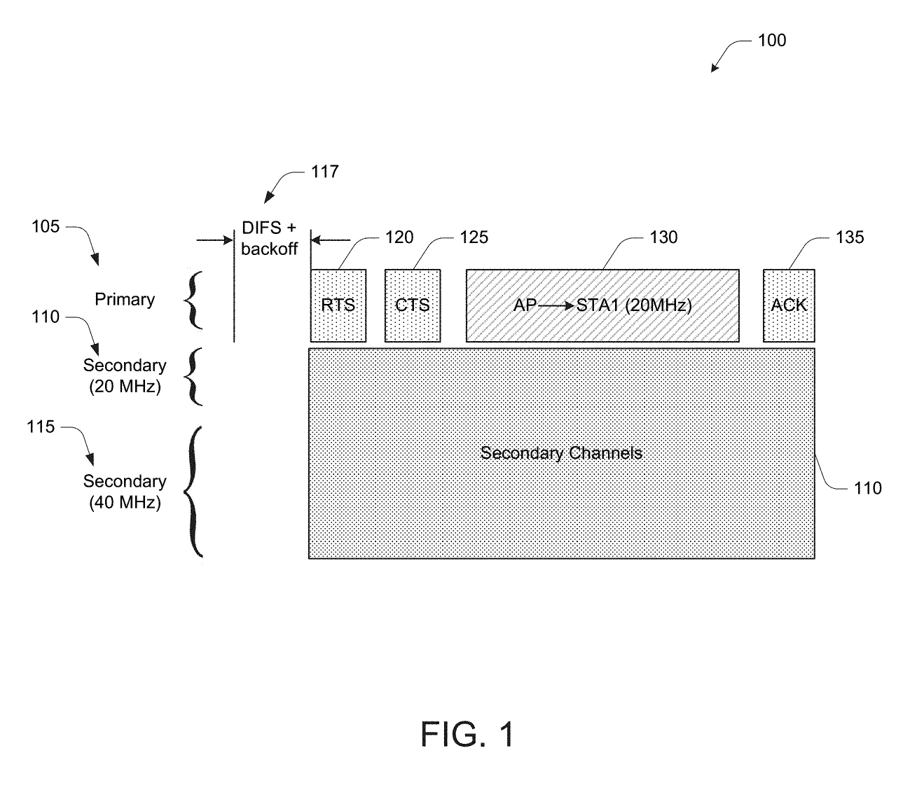

FIG. 1 shows a representative diagram of exemplary channels used to communicate between an AP and an STA, e.g. an IEEE 802.11a/n 20 MHz STA. With reference to FIG. 1, the channels 105, 110, and 115 can be further divided based on different frequency bands, for example, a primary channel 105 and two secondary channels 110, 115. The AP can communicate to the STA on the primary channel 105. After a distributed coordination function interframe space (DIFS) and a backoff timer 117, the AP can send a request to send (RTS) 120 to the STA. After receiving a clear-to-send (CTS) frame 125, the AP can send data frames to the STA1 130 over the primary channel 105, e.g., a 20 MHz capable channel. After the completion of the transmission, the AP can receive an ACK message 135 from STA1 135.

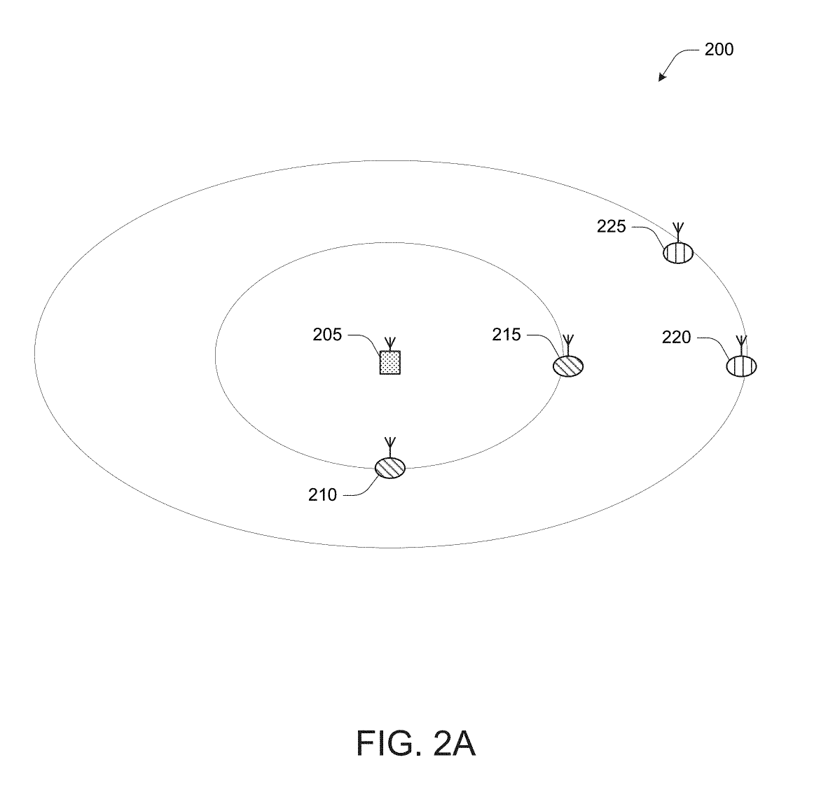

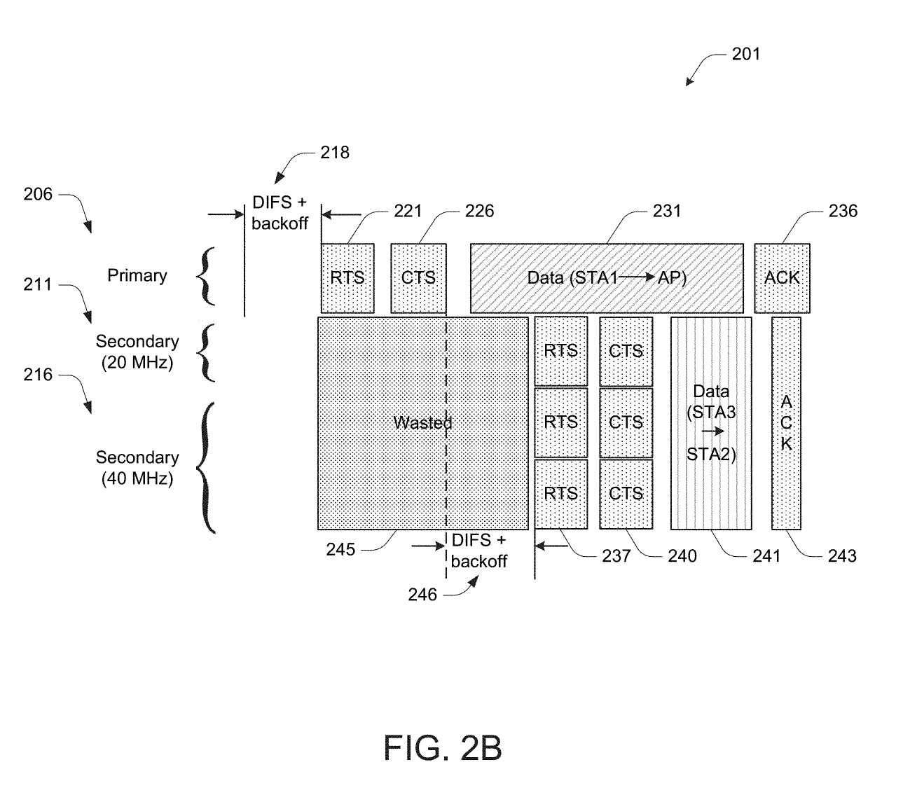

FIG. 2 shows a schematic diagram illustrating systems and methods of using non cell-edge (CE) STAs (STA2 215) as relay to improve the uplink throughput of CE STA (STA3 220). FIG. 2A shows an exemplary network environment comprising a BSS 200 with a 20 MHz STA 210 and 80 MHz STAs 204, 215, 220 and 225. With reference to FIG. 2A, an AP 205 can instruct CE STAs (e.g. STA3 220) to use the available secondary channels to transmit uplink data to a relay STA (e.g. STA2 215) when the primary channel is occupied by a legacy STA (e.g. STA1 210). The legacy STA can be, for example, STAs that can operate at 20 and/or 40 MHz. The relay STA 215 then forwards the data to the AP 205 when it accesses the medium. This can increase the uplink throughput of CE STAs.

FIG. 2B shows an example conventional attempt at overcoming the underutilization of the secondary channels using MAC protocols. In FIG. 2B, the AP 205 can instruct CE STAs (e.g. STA3 220) to use the available secondary channels 211, 216 to transmit uplink data to a relay STA (e.g. STA2 215) when the primary channel 206 is occupied by a legacy STA (e.g. STA1 210). The relay STA 215 then forwards the data to the AP 205 when it accesses the medium. This can increase the uplink throughput of CE STAs.

As can be seen in the systems and methods illustrated in FIGS. 1 and 2, the secondary channels (e.g., secondary channels 110, 115 of FIG. 1 and secondary channels 211, 216 of FIG. 2) can be underutilized 245 when legacy 802.11a/n STAs are associated with an 802.11ac (or 802.11ax) AP. Alternatively, the secondary channels (e.g., secondary channels 110, 115 of FIG. 1 and secondary channels 211, 216 of FIG. 2) can be underutilized 245 when a STA 210 is located at the edge of the coverage area of the AP 205 and cannot support 80 MHz transmission and reception, for example due to low SNR characteristics. Conventional systems and methods have been designed for uplink transmissions from a CE STA (e.g., CE STAs 220, 225) to the AP 205 but not for the downlink transmissions from the AP 205 to a CE STA (e.g., CE STAs 220, 225). Furthermore, the CE STAs (e.g., CE STAs 220, 225) may follow clear channel assessment (CCA) rules defined in the IEEE 802.11 specification to access the secondary channels, which may lead to high overhead and spectrum waste 245 as shown in FIG. 2B.

Disclosed herein are systems and methods directed to a MAC protocol that can coordinate the AP with a relay STA to improve both the uplink and downlink throughput of a CE STA by using underutilized secondary channels. The disclosed systems and methods can be used to improve the performance of cell-edge STAs without affecting the performance of non-cell-edge STAs. In various embodiments, RTS frames can be used to instruct relay STAs to transmit data to CE STAs over idle secondary channels while the AP transmits data to legacy (e.g. 20 or 40 MHz) STAs over primary channels.

The downlink throughput of CE STAs can be enhanced by coordination between the transmissions of APs and relay STAs. The transmission between relay STAs and CE STAs and the transmission between APs and 20/40 MHz STAs can be coordinated by RTS/CTS exchanges over a wide bandwidth (e.g. 80 MHz), which reduces overhead.

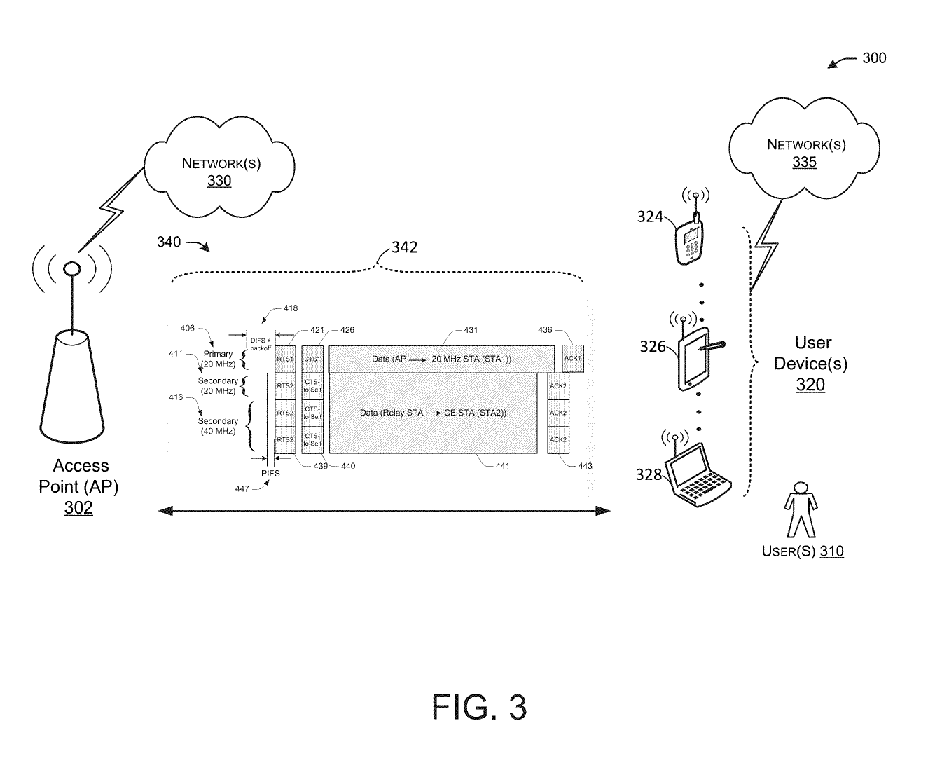

FIG. 3 is a network diagram illustrating an example network environment, according to some example embodiments of the present disclosure. Wireless network 300 may include one or more devices 320 and one or more access point(s) (AP) 302, which may communicate in accordance with IEEE 802.11 communication standards, including IEEE 802.11ax. The device(s) 320 may be mobile devices that are non-stationary and do not have fixed locations.

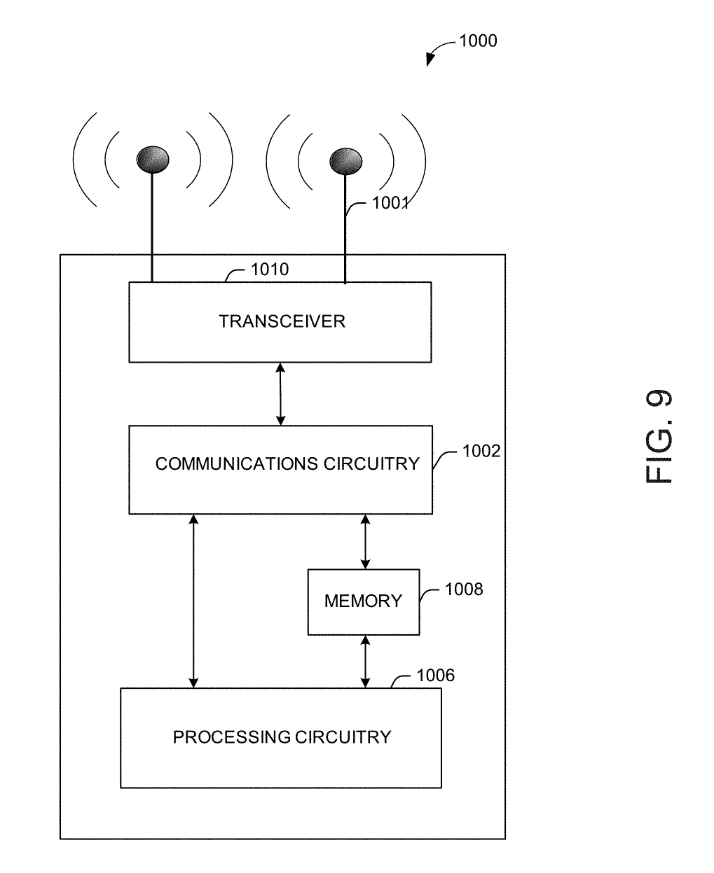

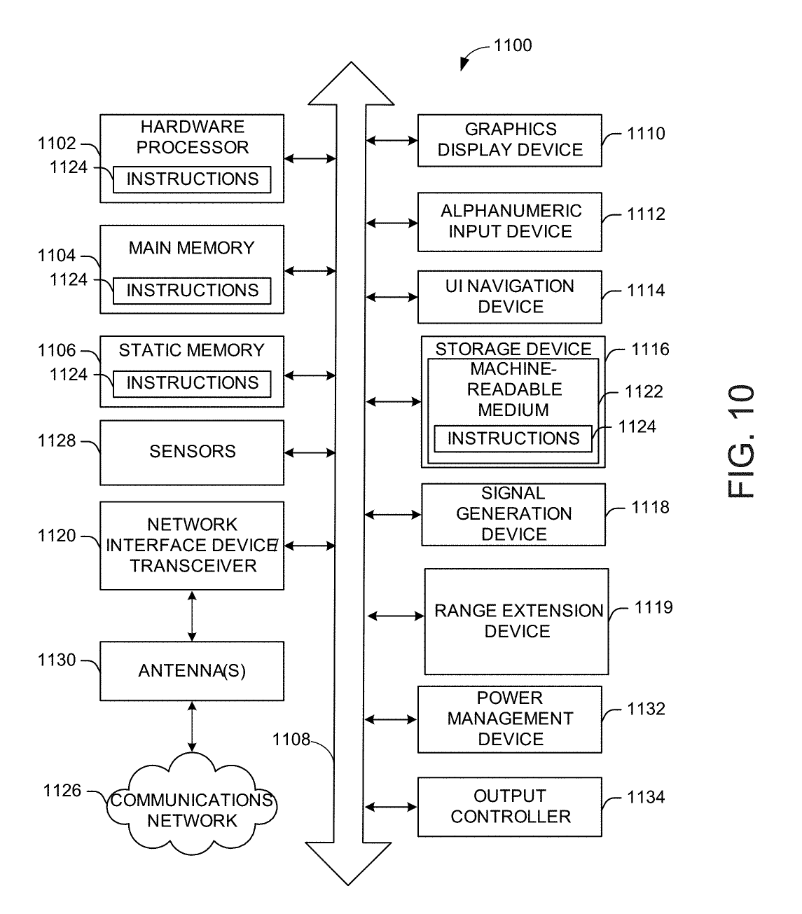

The user device(s) 320 (e.g., 324, 326, or 328) may include any suitable processor-driven user device including, but not limited to, a desktop user device, a laptop user device, a server, a router, a switch, an access point, a smartphone, a tablet, wearable wireless device (e.g., bracelet, watch, glasses, ring, etc.) and so forth. In some embodiments, the user devices 320 and AP 302 may include one or more computer systems similar to that of the functional diagram of FIG. 9 and/or the example machine/system of FIG. 10, to be discussed further.

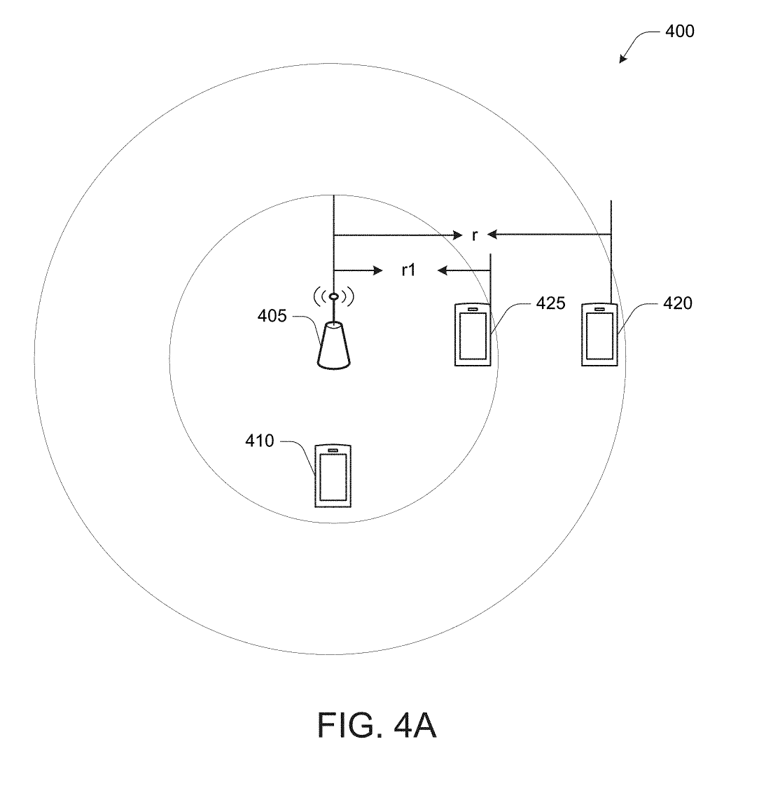

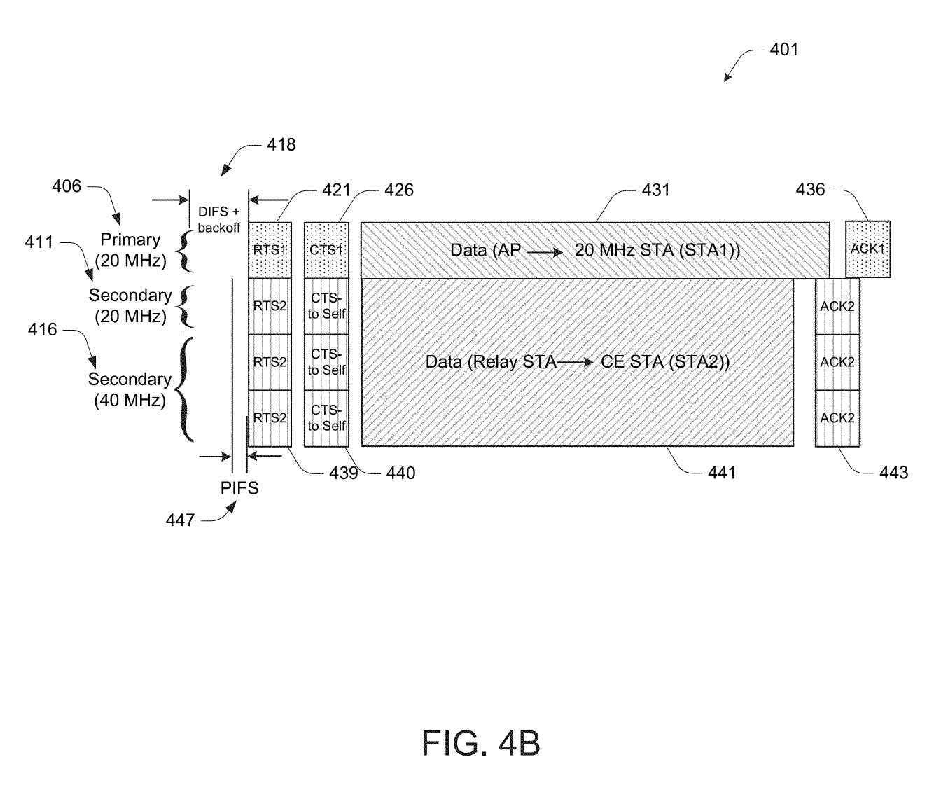

FIGS. 4A and 4B illustrate the operation of the aspects of the disclosure in accordance with the systems and methods described herein. In particular, FIG. 4A shows an exemplary wireless network configuration 400 in accordance with the disclosed systems and methods. In this example, there is a 20/40/80 MHz capable AP 405, a 20 MHz STA (STA1) 410, a relay STA 425, and a CE STA (STA2) 420. The relay STA 425 and CE STA 420 can be 80 MHz transmission/reception capable.

FIG. 4B shows a representative diagram 401 of exemplary channels used to communicate between an AP (e.g., AP 405) and an STA (e.g., STA1 410) on a primary channel 406, and the channels used to communicate between a relay STA (e.g. relay STA 425) and a CE STA (e.g. CE STA2 420). The AP 405 can communicate with STA1 410 over a primary 20 MHz channel 406. The AP 405 can do so by first waiting for a Distributed Coordination Function (DCF) Interframe Space (DIFS) and backoff timer period 418. Next, the AP 405 can send a RTS1 frame 421 to STA1 410 and await for the CTS1 response frame 426. Next, the AP 405 can send data 431 to STA1 410. Finally, the STA1 410 can return an ACK1 message 436 upon completion of the data transmission. At substantially the same time as the preceding communication between the AP 405 and STA1 410, the relay STA 425 can communicate with STA2 420, a CE STA on secondary channels (e.g. a secondary 20 MHz 411 and a secondary 40 MHz channel 416. The relay STA 425 can first send RTS2 frames 439 along the secondary channels 411, 416. Upon receiving CTS-to-self frames 440 from STA2 420, the relay STA 425 can send data to STA2 420. Finally, the relay STAs 425 can receive acknowledgement frames, ACK2 443, from STA 420 upon the completion of the data transmission.

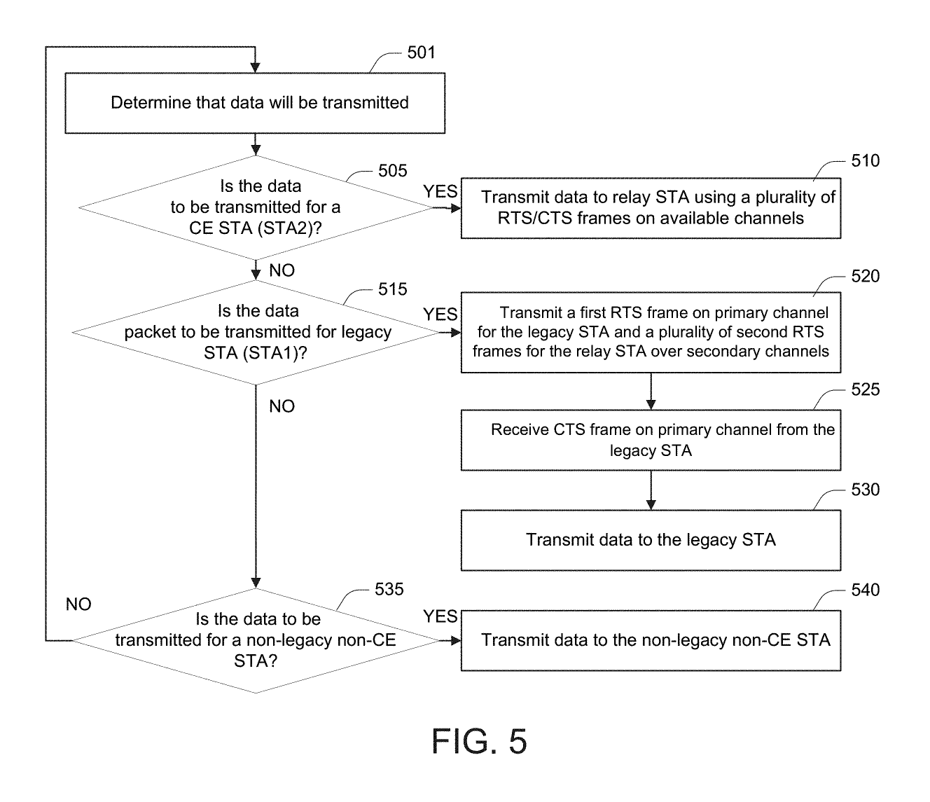

FIGS. 5-7 show exemplary flowcharts illustrating the operation of an AP (e.g. AP 405 of FIG. 4A), a relay STA (e.g., a relay STA 425 of FIG. 4A) and a CE STA (e.g. a CE STA 420 of FIG. 4A) in accordance with the systems and methods disclosed herein.

With reference to FIG. 5, the operation 500 of an exemplary AP (e.g., AP 405 of FIG. 4A) is provided in accordance with the systems and methods disclosed herein. At block 501, the AP (e.g., AP 405 of FIG. 4A) can determine that data will be transmitted, for example, based on various transmission and reception of data packets over an operating network. The AP (e.g., AP 405 of FIG. 4A) can then access the medium when it has data comprising data packets to transmit, for example by following CCA rules defined in IEEE 802.11ac specification. At block 505, the AP (e.g., AP 405 of FIG. 4A) can determine that the data packet to be transmitted is intended for a CE STA (e.g., STA2 420 of FIG. 4A). This determination can be based on, for example, header and/or preamble information in the data packets. At block 510, the AP (e.g., AP 405 of FIG. 4A) can transmit the data to the relay STA (e.g., relay STA 425 of FIG. 4A) over an available channel bandwidth (e.g., a wide bandwidth, for example, 80 MHz) using a plurality of RTS/CTS exchanges (e.g., plurality of RTS/CTS exchanges 439, 440 of FIG. 4B) on a on available channels, for example using the procedure defined in IEEE 802.11ac. These exchanges can be performed, for example, in accord with procedures defined in IEEE 802.11ac. At block 515, the AP (e.g., AP 405 of FIG. 4A) can determine that the data to be transmitted is intended for a legacy (e.g., 20 or 40 MHz) STA (e.g., STA1 410 of FIG. 410). At block 520 the AP (e.g., AP 405 of FIG. 4A) can transmit an RTS frame (e.g., RTS1 421 of FIG. 4B) on the primary channel (e.g., primary channel 406 of FIG. 4B) for STA1 (e.g., STA1 410 of FIG. 4A) and a plurality of RTS frames (e.g., RTS2s 439 of FIG. 4B) for the relay STA (e.g., a relay STA 425 of FIG. 4A) over available secondary channels (e.g., plurality of secondary channels 411 and 416 of FIG. 4B). In various embodiments, the RTS2s (e.g., RTS2s 439 of FIG. 4B) transmitted on the secondary channels to the relay STA (e.g., a relay STA 425 of FIG. 4A) can indicate that the relay STA (e.g., relay STA 425 of FIG. 4A) can transmit data to the CE STA (e.g., STA2 420 of FIG. 4A) on the secondary channels. At block 525, the AP (e.g., AP 405 of FIG. 4A) can receive the CTS frame (e.g., CTS1 426 of FIG. 4B) on the primary channel (e.g., primary channel 406 of FIG. 4B). At block 530 the AP (e.g., AP 405 of FIG. 4A) can transmit data to STA1 (e.g., STA1 410 of FIG. 4A), for example, using the procedure defined in IEEE 802.11. At block 535, the AP (e.g., AP 405 of FIG. 4A) can determine that the data to be transmitted is intended for an 80 MHz capable non-CE STA. At block 540, the AP (e.g., AP 405 of FIG. 4A) may transmit data to the non-CE STA on available channel bandwidth, for example using the procedure defined in IEEE 802.11ac.

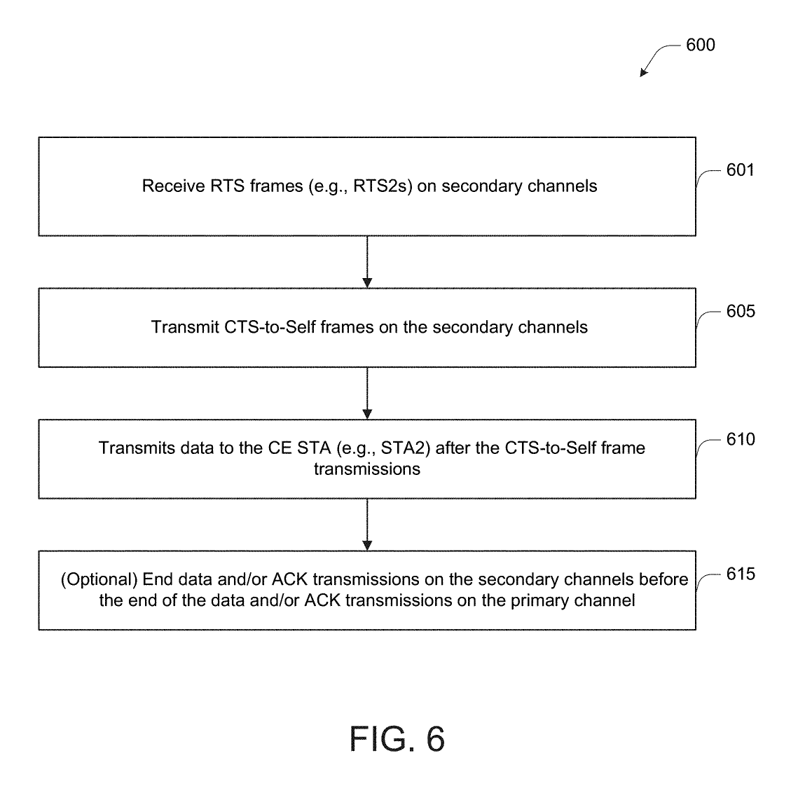

With reference to FIG. 6, a flowchart of the operation 600 of an exemplary relay STA (e.g., a relay STA 425 of FIG. 4A) is provided in accordance with the systems and methods disclosed herein. At block 601 the relay STA (e.g., a relay STA 425 of FIG. 4A) can receive the RTS frames (RTS2s) on the secondary channels (e.g., plurality of secondary channels 411 and 416 of FIG. 4B). At block 605 the relay STA (e.g., a relay STA 425 of FIG. 4A) can transmit CTS-to-Self frames (e.g. CTS-to-SELF frames 440 of FIG. 4B) on the available secondary channels (e.g., plurality of secondary channels 411 and 416 of FIG. 4B) indicating to the CE STA (e.g., STA2 420 of FIG. 4A) that the relay STA (e.g., relay STA 425 of FIG. 4A) has data to transmit. In one embodiment, unlike a CTS frame, which may be transmitted by an intended receiver as a response to a RTS frame, a CTS-to-self frame can be transmitted by a transmitter (for example, the relay STA) to block other STAs from transmitting during the time indicated in the duration field of the CTS-to-self frame and also to indicate to its intended receiver that the transmitter (for example, the relay STA) has data to transmit. After transmission of the CTS-to-Self frame, the transmitter (relay STA) transmits data packets to the CE STA. At block 610 the relay STA (e.g., relay STA 425 of FIG. 4A) can transmits data frame(s) to the CE STA (e.g., STA2 420 of FIG. 4A) after the end of the CTS-to-Self frame transmission, and in some cases, a Short Interframe Space (SIFS) time. At block 615, optionally in some embodiments, the relay STA may end the data and/or ACK transactions before the end of the data and/or ACK transactions on the primary channel (e.g., primary channel 406 of FIG. 4B).

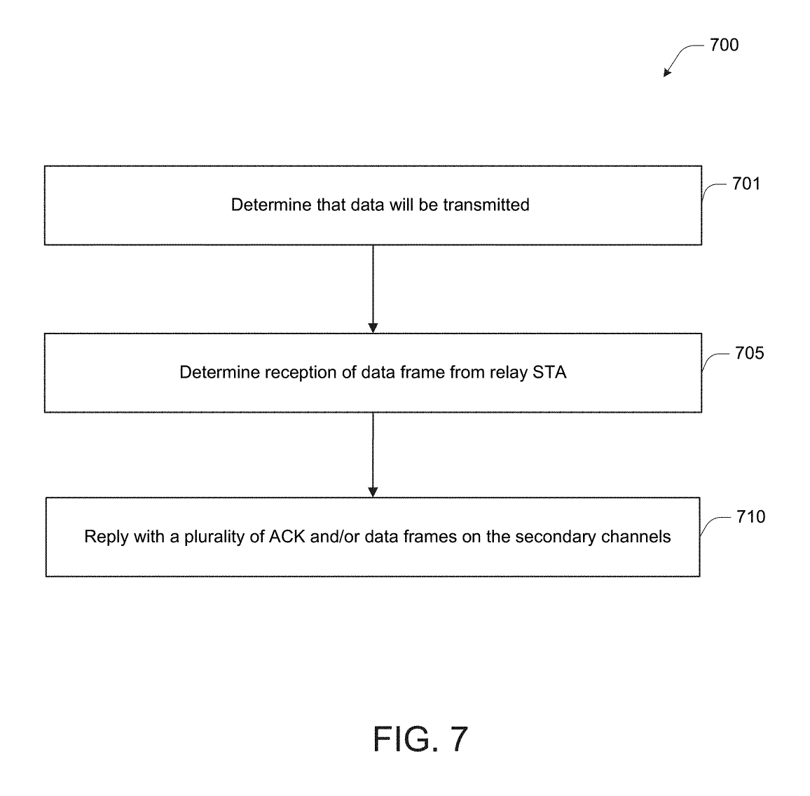

With reference to FIG. 7, a flowchart of the operation 700 of an exemplary CE STA (e.g., STA2 420 of FIG. 4A) is provided in accordance with the systems and methods disclosed herein. At block 701 the CE STA (e.g., STA2 420 of FIG. 4A) can determine that data will be transmitted, for example, based on various transmission and reception of data packets over an operating network. It can access the medium when it has uplink data packet to transmit, e.g. by following CCA rules defined in IEEE 802.11ac specification. At block 705, the CE STA (e.g., STA2 420 of FIG. 4A) can determine the reception of a data frame is from the relay STA. This determination can be based on, for example, header and/or preamble information in the data packets. At block 710 the CE STA (e.g., STA2 420 of FIG. 4A) can reply with a plurality of ACK and/or data frames on secondary channels to indicate that it received the data frame.

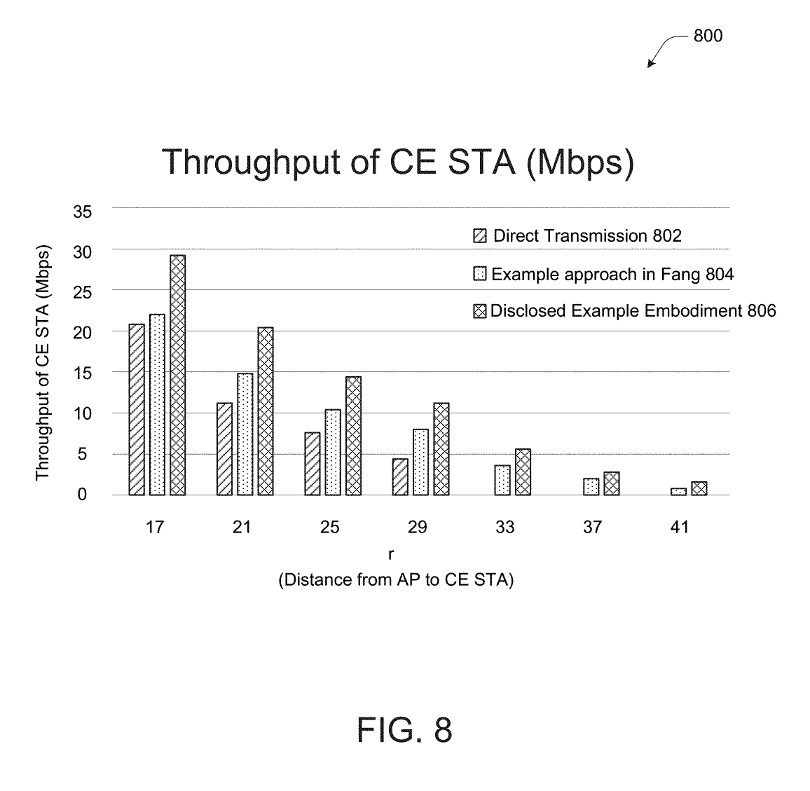

FIG. 8 shows the throughput of the CE STA by using embodiments of the present disclosure 806, a direct transmission technique (from AP to CE STA) 802, and another example approach presented in Fang, Juan, and I-Tai Lu. “Efficient Utilization of Extended Bandwidth in 802.11 ac With and Without Overlapping Basic Service Sets.” Electronics Letters 50.24 (2014): 1884-1886 (“Fang”) 804 at a plurality of distances r (meters). In the example presented in Fang, the distance from the AP to the relay STA, r1, is set to approximately 13 meters. As demonstrated in the FIG. 8, the CE STA can obtain a higher throughput using the disclosed systems and methods. For example, when the distance between the CE STA and the AP is approximately 29 meters, the disclosed systems and methods can achieve up to approximately 2.6X throughput gain over the direct transmission between the AP and the CE STA.

Returning to FIG. 3, any of the user device(s) 320 (e.g., user devices 324, 326, 328), and AP 302 may be configured to communicate with each other via one or more communications networks 330 and/or 335 wirelessly or wired. Any of the communications networks 330 and/or 335 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 330 and/or 335 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 330 and/or 335 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 320 (e.g., user devices 324, 326, 328), and AP 102 of FIG. 3 may include one or more communications antennae. Communications antenna may be any suitable type of antenna corresponding to the communications protocols used by the user device(s) 320 (e.g., user devices 324, 324 and 328), and AP 302 of FIG. 3. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, or the like. The communications antenna may be communicatively coupled to a radio component to transmit and/or receive signals, such as communications signals to and/or from the user devices 320.

Any of the user devices 320 (e.g., user devices 324, 326, 328), and AP 302 of FIG. 3 may include any suitable radio and/or transceiver for transmitting and/or receiving radio frequency (RF) signals in the bandwidth and/or channels corresponding to the communications protocols utilized by any of the user device(s) 320 and AP 302 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n), 5 GHz channels (e.g. 802.11n, 802.11ac), or 60 GHZ channels (e.g. 802.11ad). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

Typically, when an AP (e.g., AP 302 of FIG. 3) establishes communication with one or more user devices 320 (e.g., user devices 324, 326, and/or 328), the AP may communicate in the downlink direction by sending data frames. The data frames may be preceded by one or more preambles (e.g., preamble 340 of FIG. 3) that may be part of one or more headers. These preambles may be used to allow the user device to detect a new incoming data frame from the AP. A preamble may be a signal used in network communications to synchronize transmission timing between two or more devices (e.g., between the APs and user devices).

FIG. 9 shows a functional diagram of an exemplary communication station 1000 in accordance with some embodiments. In one embodiment, FIG. 9 illustrates a functional block diagram of a communication station that may be suitable for use as an AP 302 (FIG. 3) or communication station user device 320 (FIG. 3) in accordance with some embodiments. The communication station 1000 may also be suitable for use as a handheld device, mobile device, cellular telephone, smartphone, tablet, netbook, wireless terminal, laptop computer, wearable computer device, femtocell, High Data Rate (HDR) subscriber station, access point, access terminal, or other personal communication system (PCS) device.

The communication station 1000 may include communications circuitry 1002 and a transceiver 1010 for transmitting and receiving signals to and from other communication stations using one or more antennas 1001. The communications circuitry 1002 may include circuitry that can operate the physical layer communications and/or medium access control (MAC) communications for controlling access to the wireless medium, and/or any other communications layers for transmitting and receiving signals. The communication station 1000 may also include processing circuitry 1006 and memory 1008 arranged to perform the operations described herein. In some embodiments, the communications circuitry 1002 and the processing circuitry 1006 may be configured to perform operations detailed in FIGS. 1-8.

In accordance with some embodiments, the communications circuitry 1002 may be arranged to contend for a wireless medium and configure frames or packets for communicating over the wireless medium. The communications circuitry 1002 may be arranged to transmit and receive signals. The communications circuitry 1002 may also include circuitry for modulation/demodulation, upconversion/downconversion, filtering, amplification, etc. In some embodiments, the processing circuitry 1006 of the communication station 1000 may include one or more processors. In other embodiments, two or more antennas 1001 may be coupled to the communications circuitry 1002 arranged for sending and receiving signals. The memory 1008 may store information for configuring the processing circuitry 1006 to perform operations for configuring and transmitting message frames and performing the various operations described herein. The memory 1008 may include any type of memory, including non-transitory memory, for storing information in a form readable by a machine (e.g., a computer). For example, the memory 1008 may include a computer-readable storage device may, read-only memory (ROM), random-access memory (RAM), magnetic disk storage media, optical storage media, flash-memory devices and other storage devices and media.

In some embodiments, the communication station 1000 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 1000 may include one or more antennas 1001. The antennas 1001 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 1000 may include one or more of a keyboard, a display, a non-volatile memory port, multiple antennas, a graphics processor, an application processor, speakers, and other mobile device elements. The display may be an LCD screen including a touch screen.

Although the communication station 1000 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 1000 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 1000 may include one or more processors and may be configured with instructions stored on a computer-readable storage device memory.

FIG. 10 illustrates a block diagram of an example of a machine 1100 or system upon which any one or more of the techniques (e.g., methodologies) discussed herein may be performed. In other embodiments, the machine 1100 may operate as a standalone device or may be connected (e.g., networked) to other machines. In a networked deployment, the machine 1100 may operate in the capacity of a server machine, a client machine, or both in server-client network environments. In an example, the machine 1100 may act as a peer machine in peer-to-peer (P2P) (or other distributed) network environments. The machine 1000 may be a personal computer (PC), a tablet PC, a set-top box (STB), a personal digital assistant (PDA), a mobile telephone, wearable computer device, a web appliance, a network router, switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 1100 may include a hardware processor 1102 (e.g., a central processing unit (CPU), a graphics processing unit (GPU), a hardware processor core, or any combination thereof), a main memory 1004 and a static memory 1106, some or all of which may communicate with each other via an interlink (e.g., bus) 1108. The machine 1100 may further include a power management device 1132, a graphics display device 1110, an alphanumeric input device 1112 (e.g., a keyboard), and a user interface (UI) navigation device 1114 (e.g., a mouse). In an example, the graphics display device 1110, alphanumeric input device 1112, and UI navigation device 1114 may be a touch screen display. The machine 1100 may additionally include a storage device (i.e., drive unit) 1116, a signal generation device 1118 (e.g., a speaker), a range extension device 1119, a network interface device/transceiver 1120 coupled to antenna(s) 1130, and one or more sensors 1128, such as a global positioning system (GPS) sensor, compass, accelerometer, or other sensor. The machine 1100 may include an output controller 1134, such as a serial (e.g., universal serial bus (USB), parallel, or other wired or wireless (e.g., infrared (IR), near field communication (NFC), etc.) connection to communicate with or control one or more peripheral devices (e.g., a printer, card reader, etc.)).

The storage device 1116 may include a machine readable medium 1122 on which is stored one or more sets of data structures or instructions 1124 (e.g., software) embodying or utilized by any one or more of the techniques or functions described herein. The instructions 1124 may also reside, completely or at least partially, within the main memory 1104, within the static memory 1106, or within the hardware processor 1102 during execution thereof by the machine 1100. In an example, one or any combination of the hardware processor 1102, the main memory 1104, the static memory 1106, or the storage device 1116 may constitute machine-readable media.

The range extension device 1119 may carry out or perform any of the operations and processes described and shown above.

While the machine-readable medium 1122 is illustrated as a single medium, the term “machine-readable medium” may include a single medium or multiple media (e.g., a centralized or distributed database, and/or associated caches and servers) configured to store the one or more instructions 1124.

The term “machine-readable medium” may include any medium that is capable of storing, encoding, or carrying instructions for execution by the machine 1100 and that cause the machine 1100 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., Electrically Programmable Read-Only Memory (EPROM), or Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1124 may further be transmitted or received over a communications network 1126 using a transmission medium via the network interface device/transceiver 1120 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), Plain Old Telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 1120 may include one or more physical jacks (e.g., Ethernet, coaxial, or phone jacks) or one or more antennas to connect to the communications network 1126. In an example, the network interface device/transceiver 1120 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 1100 and includes digital or analog communications signals or other intangible media to facilitate communication of such software. The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

In an embodiment, a device can include: at least one memory that stores computer-executable instructions; and at least one processor of the one or more processors configured to access the at least one memory, wherein the at least one processor of the one or more processors is configured to execute the computer-executable instructions to: determine that the device has first data to transmit; determine that the first data to be transmitted is for a cell-edge station (CE STA); cause to send a plurality of request-to-send (RTS) frames to a relay station on one or more first channels; identify a plurality of clear-to-send (CTS) frames received from the relay station on the one or more first channels; cause to send the first data to the relay station on at least one of the one or more first channels; determine that the device has second data to transmit; determine that the second data to be transmitted is for a legacy station; cause to send a first request to send (RTS) frame to the legacy station on a primary channel; cause to send a plurality of second request-to-send (RTS) frames to the relay station on one or more secondary channels; identify an first clear to send (CTS) frame received from the legacy station on the primary channel and a plurality of second clear-to-send (CTS) frames received from the relay station on the one or more secondary channels; cause to send the second data to the legacy station on the primary channel; determine that the device has third data to transmit; determine that the third data to be transmitted is for an non-legacy non cell-edge station; cause to send a plurality of second request-to-send (RTS) frames to the station; identify a plurality of clear-to-send (CTS) frames received from the station; and cause to send the third data to the non cell-edge station. The device can include an 80 MHz capable station. The legacy station can include a 20 MHz capable or 40 MHz capable station. The relay station can include an 80 MHz capable station. The CE station can include an 80 MHz capable station. The sending of the plurality of RTS frames to the station and the receiving the plurality of CTS frames from the station can include sending the plurality of RTS frames to the relay STA and the receiving the plurality of CTS frames from the relay station over a wide bandwidth. The device can include a transceiver configured to transmit and receive wireless signals. The device can include an antenna coupled to the transceiver.

In an embodiment, a device, can include: at least one memory that stores computer-executable instructions; and at least one processor of the one or more processors configured to access the at least one memory, wherein the at least one processor of the one or more processors is configured to execute the computer-executable instructions to: identify data received from a first device; identify a plurality of request-to-send (RTS) frames on one or more secondary channels; identify a plurality of clear-to-send (CTS) frames associated with the data; and cause to send, based at least in part on the CTS frames, the data to a cell edge (CE) STA on the secondary channels. The device can include instructions to determine, using one or more of the plurality of the RTS frames, to generate the plurality of CTS-to-self frames. The device can include an 80 MHz capable station and the CE station comprises an 80 MHz capable station.

In an embodiment, a non-transitory computer-readable medium storing computer-executable instructions is described, which, when executed by a processor, cause the processor to perform operations that can include: determining that the device has first data to transmit; determining that the first data to be transmitted is for a cell-edge station (CE STA); causing to send a plurality of request-to-send (RTS) frames to a relay station on one or more first channels; identifying a plurality of clear-to-send (CTS) frames received from the relay station on the one or more first channels; causing to send the first data to the relay station on at least one of the one or more first channels; determining that the device has second data to transmit; determining that the second data to be transmitted is for a legacy station; causing to send a first request to send (RTS) frame to the legacy station on a primary channel; causing to send a plurality of second request-to-send (RTS) frames to the relay station on one or more secondary channels; identifying a first clear to send (CTS) frame received from the legacy station on the primary channel and a plurality of second clear-to-send (CTS) frames received from the relay station on the one or more secondary channels; and causing to send the second data to the legacy station on the primary channel. The device can include an 80 MHz capable station. The legacy station can include a 20 MHz capable or 40 MHz capable station. The relay station can include an 80 MHz capable station. The CE station can include an 80 MHz capable station. The sending of the plurality of RTS frames to the station and the receiving the plurality of CTS frames from the station can include sending the plurality of RTS frames to the relay station and the receiving the plurality of CTS frames from the relay station over a wide bandwidth.

In an embodiment, a non-transitory computer-readable medium storing computer-executable instructions which, when executed by a processor, cause the processor to perform operations that can include: identifying data received from a first device; identifying a plurality of request-to-send (RTS) frames on one or more secondary channels; identifying a plurality of clear-to-send (CTS) frames associated with the data; and causing to send, based at least in part on the CTS frames, the data to a cell edge (CE) station on the secondary channels. The operations can further include determining, using one or more of the plurality of the RTS frames, to generate the of CTS-to-self frames. The device can include an 80 MHz capable STA and the CE station can include an 80 MHz capable station.

In an embodiment, a method can include: determining that the device has first data to transmit; determining that the first data to be transmitted is for a cell-edge station (CE STA); causing to send a plurality of request-to-send (RTS) frames to a relay station on one or more first channels; identifying a plurality of clear-to-send (CTS) frames received from the relay station on the one or more first channels; causing to send the first data to the relay station on at least one of the one or more first channels; determining that the device has second data to transmit; determining that the second data to be transmitted is for a legacy station; causing to send a first request to send (RTS) frame to the legacy station on a primary channel; causing to send a plurality of second request-to-send (RTS) frames to the relay station on one or more secondary channels; identifying a first clear to send (CTS) frame received from the legacy station on the primary channel and a plurality of second clear-to-send (CTS) frames received from the relay station on the one or more secondary channels; and causing to send the second data to the legacy station on the primary channel. The device can include an 80 MHz capable station. The legacy station can include a 20 MHz capable or 40 MHz capable station. The relay station can include an 80 MHz capable station. The CE station can include an 80 MHz capable station. The sending of the plurality of RTS frames to the station and the receiving the plurality of CTS frames from the station can include the sending of the plurality of RTS frames to the relay station and the receiving the plurality of CTS frames from the relay station over a wide bandwidth. An apparatus can include means for performing a method as described above. A system can include at least one memory device having programmed instruction that, in response to execution, cause at least one processor to perform the method as described above. A machine readable medium including code, when executed, can cause a machine to perform the method described above.

In an embodiment, an apparatus can include: means for determining that the device has first data to transmit; means for determining that the first data to be transmitted is for a cell-edge station (CE STA); means for causing to send a plurality of request-to-send (RTS) frames to a relay station on one or more first channels; means for identifying a plurality of clear-to-send (CTS) frames received from the relay station on the one or more first channels; means for causing to send the first data to the relay station on at least one of the one or more first channels; means for determining that the device has second data to transmit; means for determining that the second data to be transmitted is for a legacy station; means for causing to send a first request to send (RTS) frame to the legacy station on a primary channel; means for causing to send a plurality of second request-to-send (RTS) frames to the relay station on one or more secondary channels; means for identifying a first clear to send (CTS) frame received from the legacy station on the primary channel and a plurality of second clear-to-send (CTS) frames received from the relay station on the one or more secondary channels; and means for causing to send the second data to the legacy station on the primary channel. The device can include an 80 MHz capable station. The legacy station can include a 20 MHz capable or 40 MHz capable station. The relay station can include an 80 MHz capable station. The CE station can include an 80 MHz capable station. The sending of the plurality of RTS frames to the station and the receiving the plurality of CTS frames from the station can include the sending of the plurality of RTS frames to the relay station and the receiving the plurality of CTS frames from the relay station over a wide bandwidth.

In an embodiment, a method can include: identifying data received from a first device; identifying a plurality of request-to-send (RTS) frames on one or more secondary channels; identifying a plurality of clear-to-send (CTS) frames associated with the data; and

causing to send, based at least in part on the CTS frames, the data to a cell edge (CE) station on the secondary channels. The operations can further include determining, using one or more of the plurality of the RTS frames, to generate the of CTS-to-self frames. The device can include an 80 MHz capable STA and the CE station can include an 80 MHz capable station. An apparatus can include means for performing a method as described above. A system can include at least one memory device having programmed instruction that, in response to execution, cause at least one processor to perform the method described above. A machine readable medium including code, when executed, can cause a machine to perform the method described above.

In an embodiment, an apparatus can include: means for identifying data received from a first device; means for identifying a plurality of request-to-send (RTS) frames on one or more secondary channels; means for identifying a plurality of clear-to-send (CTS) frames associated with the data; and means for causing to send, based at least in part on the CTS frames, the data to a cell edge (CE) station on the secondary channels. The operations can further include means for determining, using one or more of the plurality of the RTS frames, to generate the of CTS-to-self frames. The device can include an 80 MHz capable STA and the CE station can include an 80 MHz capable station. An apparatus can include means for performing a method as described above. Machine-readable storage including machine-readable instructions, when executed, can implement a method as described above. Machine-readable storage including machine-readable instructions, when executed, can implement a method or realize an apparatus as described above.

The word “exemplary” is used herein to mean “serving as an example, instance, or illustration.” Any embodiment described herein as “exemplary” is not necessarily to be construed as preferred or advantageous over other embodiments. The terms “computing device”, “user device”, “communication station”, “station”, “handheld device”, “mobile device”, “wireless device” and “user equipment” (UE) as used herein refers to a wireless communication device such as a cellular telephone, smartphone, tablet, netbook, wireless terminal, laptop computer, a femtocell, High Data Rate (HDR) subscriber station, access point, printer, point of sale device, access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as ‘communicating’, when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

The term “access point” (AP) as used herein may be a fixed station. An access point may also be referred to as an access node, a base station, or some other similar terminology known in the art. An access terminal may also be called a mobile station, user equipment (UE), a wireless communication device, or some other similar terminology known in the art. Embodiments disclosed herein generally pertain to wireless networks. Some embodiments can relate to wireless networks that operate in accordance with one of the IEEE 802.11 standards.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may be used in conjunction with one or more types of wireless communication signals and/or systems following one or more wireless communication protocols, for example, Radio Frequency (RF), Infra Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, Enhanced Data rates for GSM Evolution (EDGE), or the like. Other embodiments may be used in various other devices, systems, and/or networks.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, can be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that can direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device, comprising:
at least one memory that stores computer-executable instructions; and
at least one processor of the one or more processors configured to access the at least one memory, wherein the at least one processor of the one or more processors is configured to execute the computer-executable instructions to:
determine that the device has first data to transmit;
determine that the first data to be transmitted is for a cell-edge station (CE STA);
cause to send a plurality of request-to-send (RTS) frames to a relay station on one or more first channels;
identify a plurality of clear-to-send (CTS) frames received from the relay station on the one or more first channels;
cause to send the first data to the relay station on at least one of the one or more first channels;
determine that the device has second data to transmit;
determine that the second data to be transmitted is for a legacy station;
cause to send a first request to send (RTS) frame to the legacy station on a primary channel;
cause to send a plurality of second request-to-send (RTS) frames to the relay station on one or more secondary channels;
identify an first clear to send (CTS) frame received from the legacy station on the primary channel and a plurality of second clear-to-send (CTS) frames received from the relay station on the one or more secondary channels;
cause to send the second data to the legacy station on the primary channel;
determine that the device has third data to transmit;
determine that the third data to be transmitted is for a non-legacy non cell-edge station;
cause to send a plurality of second request-to-send (RTS) frames to the station;
identify a plurality of clear-to-send (CTS) frames received from the station; and
cause to send the third data to the non cell-edge station.

2. The device of claim 1, wherein the device comprises an 80 MHz capable station.

3. The device of claim 1, wherein the legacy station comprises a 20 MHz capable or 40 MHz capable station.

4. The device of claim 1, wherein the relay station comprises an 80 MHz capable station.

5. The device of claim 1, wherein the CE station comprises an 80 MHz capable station.

6. The device of claim 1, wherein the sending of the plurality of RTS frames to the station and the receiving the plurality of CTS frames from the station comprises sending of the plurality of RTS frames to the relay STA and the receiving the plurality of CTS frames from the relay station over a wide bandwidth.

7. The device of claim 1, further comprising a transceiver configured to transmit and receive wireless signals and an antenna coupled to the transceiver.

8. The device of claim 7, further comprising a communication circuitry that determines the data to be sent by the transceiver and the antenna.

9. A device, comprising:
at least one memory that stores computer-executable instructions; and
at least one processor of the one or more processors configured to access the at least one memory, wherein the at least one processor of the one or more processors is configured to execute the computer-executable instructions to:
identify data received from a first device;
identify a plurality of request-to-send (RTS) frames on one or more secondary channels;
identify a plurality of clear-to-send (CTS) frames associated with the data; and
cause to send, based at least in part on the CTS frames, the data to a cell edge (CE) STA on the secondary channels.

10. The device of claim 9, wherein the device further comprises instructions to determine, using one or more of the plurality of the RTS frames, to generate the plurality of CTS-to-self frames.

11. The device of claim 9, wherein the device comprises an 80 MHz capable station and the CE station comprises an 80 MHz capable station.

12. A non-transitory computer-readable medium storing computer-executable instructions which, when executed by a processor, cause the processor to perform operations comprising:
determining that the device has first data to transmit;
determining that the first data to be transmitted is for a cell-edge station (CE STA);
causing to send a plurality of request-to-send (RTS) frames to a relay station on one or more first channels;
identifying a plurality of clear-to-send (CTS) frames received from the relay station on the one or more first channels;
causing to send the first data to the relay station on at least one of the one or more first channels;
determining that the device has second data to transmit;
determining that the second data to be transmitted is for a legacy station;
causing to send a first request to send (RTS) frame to the legacy station on a primary channel;
causing to send a plurality of second request-to-send (RTS) frames to the relay station on one or more secondary channels;
identifying an first clear to send (CTS) frame received from the legacy station on the primary channel and a plurality of second clear-to-send (CTS) frames received from the relay station on the one or more secondary channels; and
causing to send the second data to the legacy station on the primary channel.

13. The non-transitory computer-readable medium of claim 12, wherein the device comprises an 80 MHz capable station.

14. The non-transitory computer-readable medium of claim 12, wherein the legacy station comprises a 20 MHz capable or 40 MHz capable station.

15. The non-transitory computer-readable medium of claim 12, wherein the relay station comprises an 80 MHz capable station.

16. The non-transitory computer-readable medium of claim 12, wherein the CE station comprises an 80 MHz capable station.

17. The non-transitory computer-readable medium of claim 12, wherein the sending of the plurality of RTS frames to the station and the receiving the plurality of CTS frames from the station comprises sending of the plurality of RTS frames to the relay station and the receiving the plurality of CTS frames from the relay station over a wide bandwidth.

18. A non-transitory computer-readable medium storing computer-executable instructions which, when executed by a processor, cause the processor to perform operations comprising:
identify data received from a first device;
identify a plurality of request-to-send (RTS) frames on one or more secondary channels;
identify a plurality of clear-to-send (CTS) frames associated with the data; and
cause to send, based at least in part on the CTS frames, the data to a cell edge (CE) station on the secondary channels.

19. The non-transitory computer-readable medium of claim 18, wherein the device further comprises instructions to determine, using one or more of the plurality of the RTS frames, to generate the of CTS-to-self frames.

20. The non-transitory computer-readable medium of claim 18, wherein the device comprises an 80 MHz capable STA and the CE station comprises an 80 MHz capable station.
